(19) United States
(12) Patent Application Publication
(10) Pub. No.: US 2012/0157157 A1
(43) Pub. Date: Jun. 21, 2012

(54) Sharing Contact Information

(75) Inventors: Al Chakra, Apex, NC (US); Li Chen, Cary, NC (US); Henri Fouotsop Meli, Cary, NC (US); Govindaraj Sampathkumar, Cary, NC (US)

(73) Assignee: INTERNATIONAL BUSINESS MACHINES CORPORATION, Armonk, NY (US)

(21) Appl. No.: 12/968,746

(22) Filed: Dec. 15, 2010

(51) Int. Cl. H04M 1/00

(52) U.S. Cl. 455/550.1

(57) ABSTRACT

A method for exchanging contact information includes, with a mobile computing device, establishing communication with a peer mobile computing device within a specified distance from the mobile computing device, determining if the peer mobile computing device meets a trust policy, automatically receiving contact information from the peer mobile computing device, and storing the contact information in a temporary contact list. A mobile computing system includes a processor and a memory communicatively coupled to the processor. The processor is configured to establish communication with a peer mobile computing device within a specified distance from the mobile computing device, determine if the peer mobile computing device meets a trust policy, receive contact information from the peer mobile computing device, and place the contact information in a temporary contact list stored on the memory.

### BACKGROUND

Aspects of the present invention relate in general to sharing contact information, and more particularly, to sharing contact information between two mobile devices within a particular geographic range.

People often use mobile computing devices such as cell-phones and Personal Digital Assistants (PDAs) to store contact information for the people they meet throughout their professional or social activities. Sometimes, a person may spend time with a new acquaintance but forget to exchange contact information before leaving the presence of that new acquaintance. Additionally, some people may need to leave a meeting in a hurry and do not have time to obtain contact information for the other meeting attendees or to enter that information into their mobile computing devices.

### BRIEF SUMMARY

A method for exchanging contact information includes, with a mobile computing device, establishing communication with a peer mobile computing device within a specified distance from the mobile computing device, with the mobile computing device, determining if the peer mobile computing device meets a trust policy, with the mobile computing device, automatically receiving contact information from the peer mobile computing device, and with the mobile computing device, storing the contact information in a temporary contact list.

A mobile computing system includes a processor and a memory communicatively coupled to the processor. The processor is configured to establish communication with a peer mobile computing device within a specified distance from the mobile computing device, determine if the peer mobile computing device meets a trust policy, receive contact information from the peer mobile computing device, and place the contact information in a temporary contact list stored on the memory.

A computer program product for a mobile computing device includes a computer readable storage medium having computer readable code embodied therewith. The computer readable program code includes computer readable program code configured to establish communication with a peer mobile computing device within a specified distance from the mobile computing device, computer readable program code configured to determine if the peer mobile computing device meets a trust policy, computer readable program code configured to receive contact information from the peer mobile computing device, and computer readable program code configured to place the contact information in a temporary contact list stored on the memory.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative physical computing system, according to one embodiment of principles described herein.

FIG. 2 is a diagram showing illustrative contact information sharing within a geographic range, according to one embodiment of principles described herein.

FIG. 3 is a diagram showing illustrative mobile computing device components, according to one embodiment of principles described herein.

FIG. 4 is a flowchart showing a process for exchanging contact information between mobile devices within a geographic range, according to one embodiment of principles described herein.

FIG. 5 is a diagram showing an illustrative user interface for a mobile computing device, according to one embodiment of principles described herein.

FIG. 6 is a flowchart showing an illustrative method for sharing contact information, according to one embodiment of principles described herein.

Throughout the drawings, identical reference numbers designate similar, but not necessarily identical, elements.

### DETAILED DESCRIPTION

The present specification discloses methods and systems for sharing contact information efficiently and securely. As used herein and in the appended claims, the term “contact information” will be broadly interpreted as the information need to communicate with or contact a specific person or organization. For example, contact information may include, but is not limited to, a phone number, mobile phone number, fax number, email address, physical address, mailing address, website address, instant messaging identification, employer, business name, job title and the like. In another example, contact information may include any of the type of information typically included on a business card.

According certain illustrative embodiments, a first mobile computing device such as a mobile phone establishes a connection with a second mobile computing device within a predefined geographic range such as 15 feet. A trust module of the mobile computing device then determines whether or not the owner of the second mobile computing device is someone with whom the owner of the mobile computing device would want to exchange contact information. This can be determined, for example, by whether the owners of each mobile computing device belong to the same professional or social network. Additionally or alternatively, the trust module can refer to a number of policies specified by the user in order to determine if contact information should be shared with the second mobile computing device. More details on these policies will be discussed below.

Contact information received from the second mobile computing device is placed into a temporary contact list of the first mobile computing device. Later, when the user has time, he or she can go through this temporary contact list and move any desired contact information to a permanent contact list.

Through use of methods and systems described herein, users will be able to exchange contact information automatically with one another. For example, if a professional service provider spends some time in the presence of a potential client, both the service provider and the potential client can have each other's contact information automatically placed into a temporary contact list on their mobile computing devices. This can be done without any manual exchanging of contact information.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

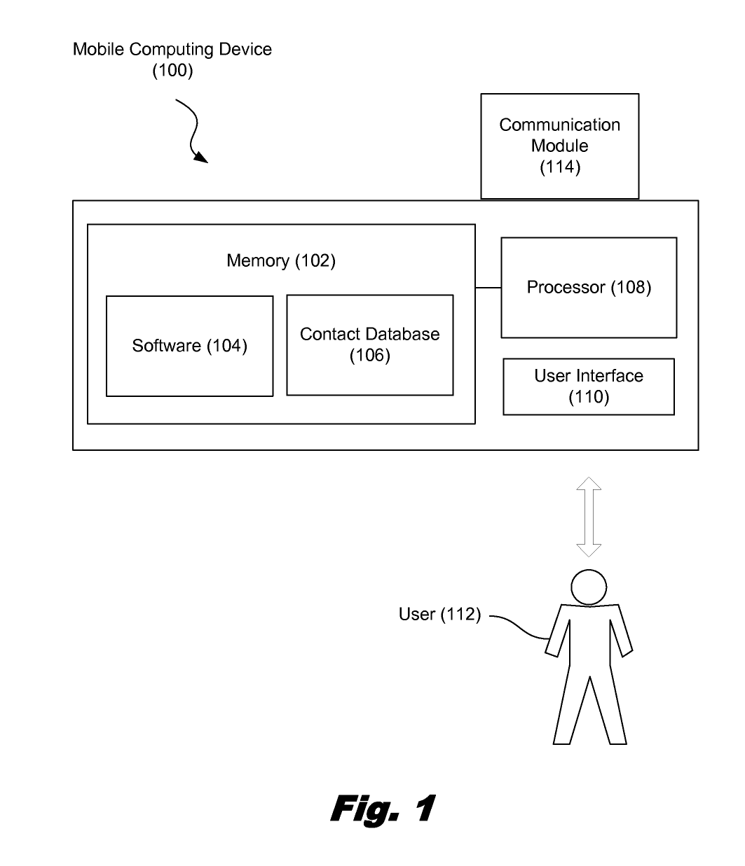

Referring now to the figures, FIG. 1 is a diagram showing an illustrative mobile computing device (100) such as a cell or mobile phone. According to certain illustrative examples, the mobile computing device (100) may include a memory (102) having software (104) and contact information (106) stored thereon.

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The mobile computing system (100) also includes a processor (108) for executing the software (104) and using or updating the data (106) in the memory (102). The software (104) may include an operating system. An operating system allows other applications to interact properly with the hardware of the mobile computing system. The other applications may include a contact database which keeps a record of a user's contacts including, for example, name, phone number, email address, etc.

A user interface (110) may provide a means for the user (112) to interact with the computing system (100). The user interface may include any collection of devices for interfacing with a human user (112). For example, the user interface (110) may be a touch-screen device that acts both as a display and as an input.

The mobile computing device also includes a communication module (114). The communication module (114) provides the hardware and software that allows the mobile computing device to communicate with external equipment such as a cell-phone tower through radio waves or another communication device in close proximity through infrared signals.

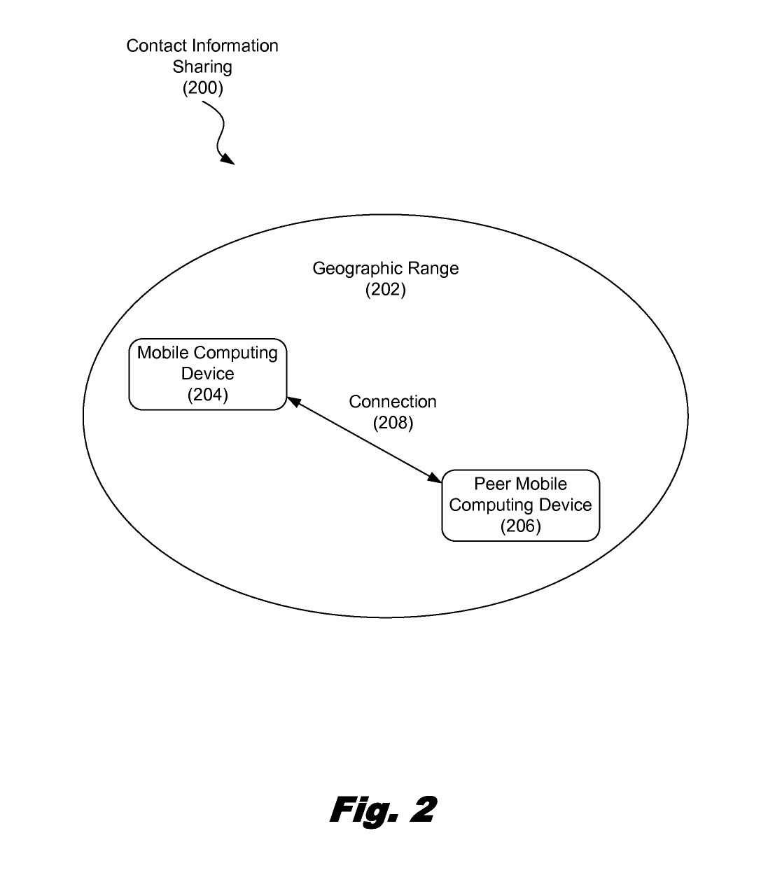

FIG. 2 is a diagram showing illustrative contact information sharing (200) within a geographic range (202). According to certain illustrative embodiments, a mobile computing device (204) and a peer mobile computing device (206) may establish a connection (208) when within a particular geographic range (202). Through this connection (208), which can be established wirelessly, information can be exchanged.

One way that a connection (208) can be established between a mobile computing device (204) and a peer mobile computing device (206) is through Wi-Fi technology. Wi-Fi is a set of engineering standards used by computing devices to communicate electronic data over wireless connections. This is typically done over radio waves. The range of Wi-Fi systems may extend from a few feet to a few miles. Other methods of communication besides Wi-Fi may be used as well, including Bluetooth, infrared or optical signals and the like. Many mobile computing devices (204, 206) are equipped with antennas which allow them to establish wireless connections with other nearby mobile computing devices. For cell-phone devices, these types of connections are typically different than the connections used to communicate with a cell-phone tower for normal call operations. According to certain illustrative embodiments, the user may be provided with a feature that, when engaged, will automatically establish wireless connections with nearby mobile computing devices.

In other examples, the mobile computing device (204) and peer mobile computing device (206) may also communicate indirectly through a network to which both have access, for example, through the Internet or a mobile telephone network. In such examples, the mobile devices may report their location to a server or other device on the network. This may be done using Global Positioning System (GPS) data obtained by each device (204, 206) or by the network using triangulation or other location services to determine the location of the device. When the proximity of the devices (204, 206) is determined by the system, the devices (204, 206) can exchange contact information as described herein via the common network with or without direct communication.

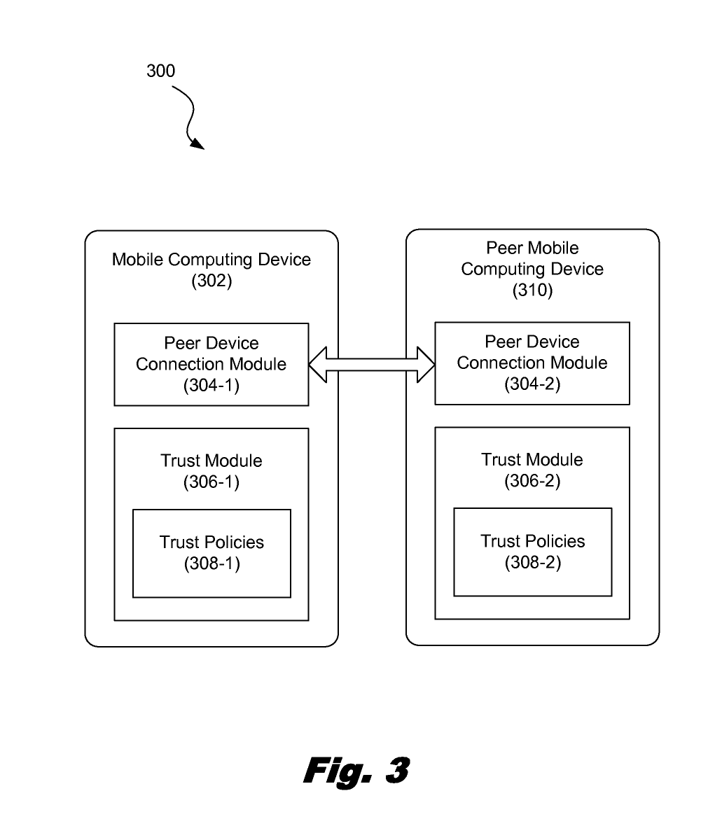

FIG. 3 is a diagram showing illustrative mobile computing device components (300). According to certain illustrative embodiments, a mobile computing device (302) includes a peer device connection module (304-1) and a trust module (306-1). Likewise, a peer mobile computing device (310) includes a peer device connection module (304-2) as well as a trust module (306-2).

The peer device connection module (304-1) of the mobile computing device (302) includes the hardware and software used to establish a wireless data connection to the peer device connection module (304-2) of the peer mobile computing device (310) and vice versa. The peer device connection modules (304) can be configured to only establish connections in accordance with policies associated with the trust module (306).

The trust module (304) includes the hardware and software to prevent the mobile computing (302, 310) device from establishing connections with unwanted peer mobile computing devices. A user of a mobile computing device often comes into close proximity with people with whom he or she may not want to trade contact information. The trust module (306) includes a set of trust policies (308) that only allow for the establishment of communication between certain mobile computing devices for purposes of exchanging contact information as described herein.

These trust policies (308) may be set by the user of the mobile computing device (302). These policies may be updated and changed regularly to fit the user's current circumstances. For example, if the user is at a particular event such as a client meeting, then he or she may set the trust policies to allow communication with any peer mobile computing device in the immediate vicinity and the exchange of contact information with any such device. In this case, any clients at the meeting having a mobile computing device capable of establishing communication as described herein can exchange contact information with the user. This way, the user does not need to ask each client he or she meets for their contact information. The contact information can be obtained automatically.

In order for there to be an exchange of contact information, the trust policies (308-1) of both the mobile computing device (302) and the trust policies (308-2) of the peer mobile computing device (310) must be followed. It may be the case that the trust policies (308-1) of the mobile computing device allow it to establish a connection with the peer mobile computing device (310), but the trust polices (308-2) of the peer mobile computing device do not allow a connection to be made to the mobile computing device (302). Therefore, a connection will not be established between the two devices (302, 310) such that no contact information is exchanged.

In some cases, the trust policies (308-1) of the mobile computing device (302) may allow it to both send and receive contact information. However, the trust polices (308-2) of the peer mobile computing device may only allow it to send or to receive information. In this case, a connection between the mobile computing device (302) and the peer mobile computing device (310) would only allow the transfer of contact information from the peer mobile computing device (310) to the mobile computing device (302) or vice versa as dictated by the trust policies (308) in place.

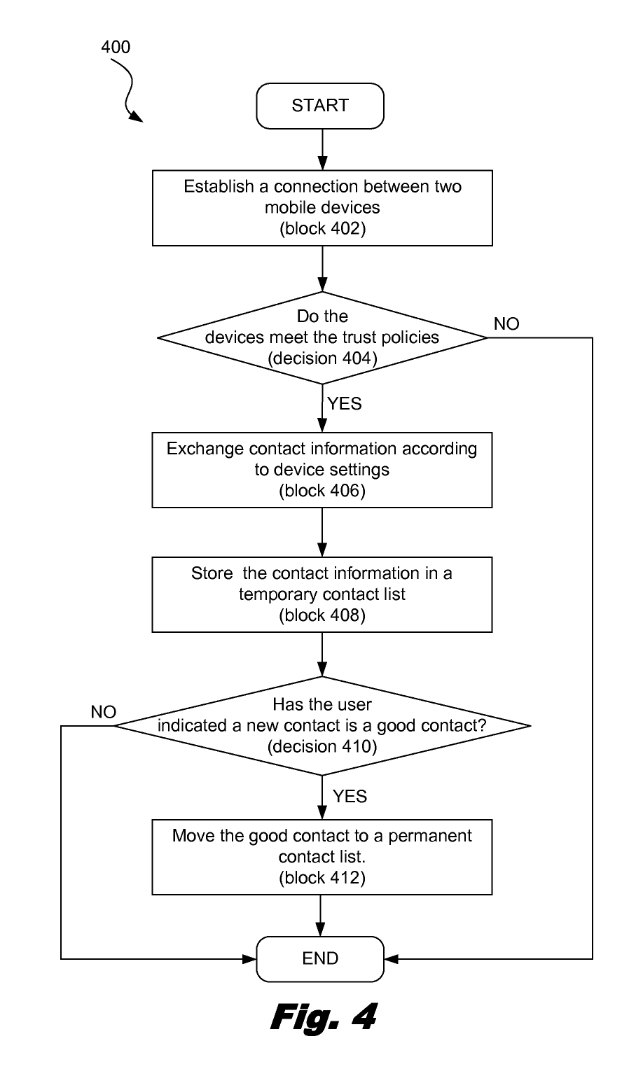

FIG. 4 is a flowchart showing a process (400) for exchanging contact information between mobile devices within a specific geographic range. According to certain illustrative embodiments, the process (400) begins by establishing (block 402) communication between two mobile computing devices. This may be done with the peer phone connection modules (e.g. 304, FIG. 3).

It is then determined (decision 404) whether or not both of the mobile computing devices meet their associated trust policies. If the mobile devices do not (decision 404, NO) meet the requisite trust policies, then no further action is taken. If the mobile computing devices do indeed (decision 404, YES) comply with their associated security policies, then the devices exchange (block 406) contact information according to the device settings. The device settings may place further limits such as exactly what information is shared or whether information is only offered or only received.

Upon receipt of any new contact information a mobile computing device stores (block 408) that contact information in a temporary contact list. The user can then review that temporary contact list at a later time to determine (decision 410) whether or not there are any good contacts therein. A contact is a good contact if it is one which the user desires to keep. If it is determined that a contact is indeed (decision 410, YES) a good contact, then that contact is moved (block 412) to a permanent contact list. If the contact is not a good contact, then it may remain in the temporary contact list or be deleted as the user prefers. In some cases, a contact within the temporary contact list will be deleted if it is not moved to the permanent contact list after a predetermined period of time.

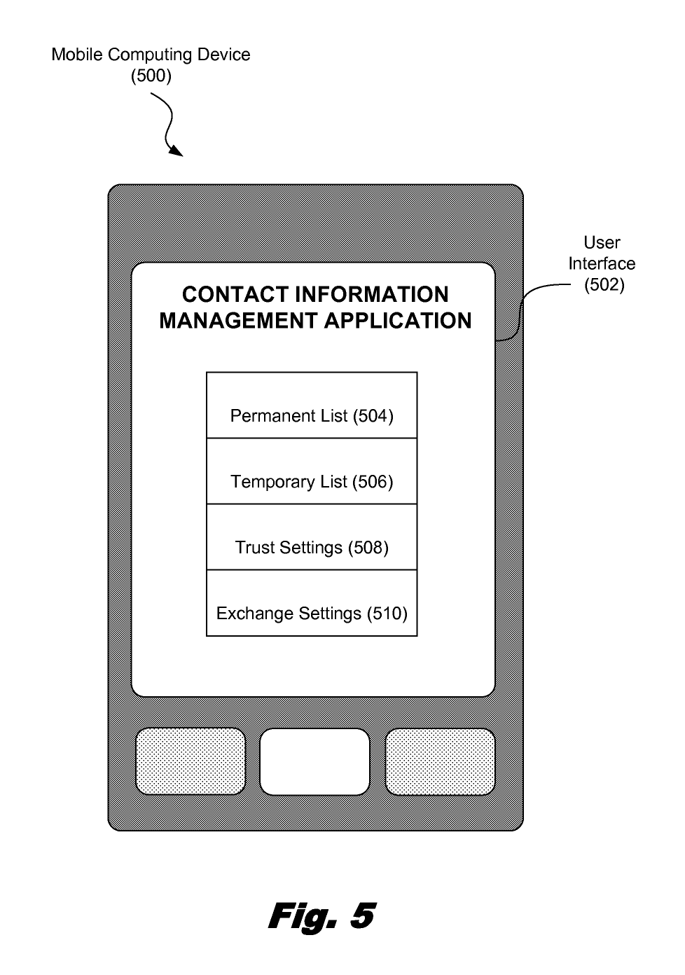

FIG. 5 is a diagram showing an illustrative user interface (502) for a mobile computing device (500). According to certain illustrative embodiments, a contact information management application running on a mobile computing device (500) may provide a user with a number of options. These options may include: view the permanent contact list (504), view the temporary contact list (506), view/change the trust settings (508), and view/change the exchange settings (510).

The view permanent contact list (504) option allows the user to view the contacts that he or she stores on the mobile computing device on a permanent basis. Alternatively, the view temporary list (508) option allows the user to view the contacts that have been acquired from other mobile computing devices within close proximity that have not been deleted or moved to permanent storage. The user can go through the temporary contact list and move desired contacts to the permanent contact list. Unwanted contacts within the temporary contact list can be manually removed by the user or allowed to expire and be automatically deleted, if that feature is in place.

In some cases, a mobile computing device may have picked up several contacts that the user does not want. For example, the user may attend a particular conference related to his or her profession. At this conference, many organizations that want to make their contact information available to people within the user's profession may have mobile computing devices that are configured to transmit contact information to mobile computing devices within range. If the user sets temporarily his or her mobile computing device to accept all contacts for the duration of the conference, he or she may receive several contacts. The user can then sort through these contacts and determines which ones should be kept. The unwanted contacts can then be removed from the temporary contact list and the user's mobile computing device.

The trust settings (508) option can allow the user to adjust the trust policies. These policies may range from completely open to highly restrictive. Particularly, these trust polices may be set to allow the exchange of information between any peer mobile computing device. Alternatively, the trust policies may require several policies to be met before contact information is exchanged.

In one example, the trust polices can be set to only allow contact information between peer mobile computing devices owned by members of a particular organization or social group. This social group can be indicated by a social networking application. For example, a user may regularly use a particular social networking application. The social networking application may allow the user to join particular groups. The social networking application may interact with the mobile computing devices of the users within that group. When those members come within close proximity to one another, their mobile computing devices may determine that both users belong to the same social network as a criteria for meeting the trust policies in place and then, if all other aspects of the trust policies are meet, automatically exchange contact information.

In one example, the user can set the trust settings to only allow the mobile computing device to establish communication with other nearby mobile computing devices at particular times. These times may be programmed into a schedule. For example, the user may know that he or she is going to attend an event where he or she desires to have his or her contact information distributed. The user can then program the mobile computing device to allow the exchange of contact information during this time, but not have contact information distributed at other times, such as while traveling to or after leaving the event.

In some cases, the user may want to either collect contact information or send contact information, but not both. The user may then adjust the trust settings (508) accordingly. For example, if the user is attending a business conference where several entities wish to have their contact information given to the user, the user may want the option to receive the contact information of these entities but not give up his or her contact information to the entities. The user may do this because he or she does not wish to be bothered with solicitations from these entities. In this case, the user can set the trust settings to only receive contact information while not sending any contact information.

In some cases, mobile computing devices are configured to store a user's schedule. In one example, the user can allow the trust settings to establish communication with other peer mobile computing devices that have the same event stored in a scheduling application. For example, an employee of a company may be planning on attending a customer conference. This customer conference event may be placed in the scheduling application of that user's mobile computing device. When the user comes into close proximity with other users who have this event scheduled in their mobile computing devices, contact information may be exchanged.

In some cases, the trust settings may be configured to require that contact information is only exchanged when the peer mobile computing device is within range of the mobile computing device for a predetermined period of time. For example, the user may only want to share contact information with those whom he or she spends a substantial amount of time rather than those whom he or she briefly passes by, for example, during an elevator ride. Consequently, the user can implement a trust setting indicating that a minimum amount of time in the presence of the peer mobile computing device will elapse before contact information is offered or exchanged.

According to certain illustrative embodiments, the temporary contact list (506) can display both the contact information as well as the reasons why the contact information was exchanged. For example, if the contact information was exchanged while the users of both mobile computing devices were at a calendared event, the event at which the contact information was obtained can be taken from a user's calendaring application on the mobile computing device and appended to contact information in the temporary contact list obtained at that event, so that the user knows when and where the contact information was obtained. In another example, if the contact information was exchanged because the users of both mobile computing devices involved in the exchange were planning on attending the same event, then that fact can be indicated to the user in the temporary contact list. This allows the user to know why he or she received a particular contact. This may help the user decide whether or not he or she wishes to move this contact to the permanent contact list.

According to certain illustrative embodiments, the user may use the exchange settings (510) to determine what information should be exchanged. For example, the user may only wish to share his or her name and phone number. In some cases, a user may also wish to share his or her email address or business address.

The examples of different trust settings (508) and exchange settings (510) described above are not exhaustive. Furthermore, the examples given above are not mutually exclusive. For example, a user may use one or more of these trust policies to determine when contact information should be shared with peer mobile computing devices.

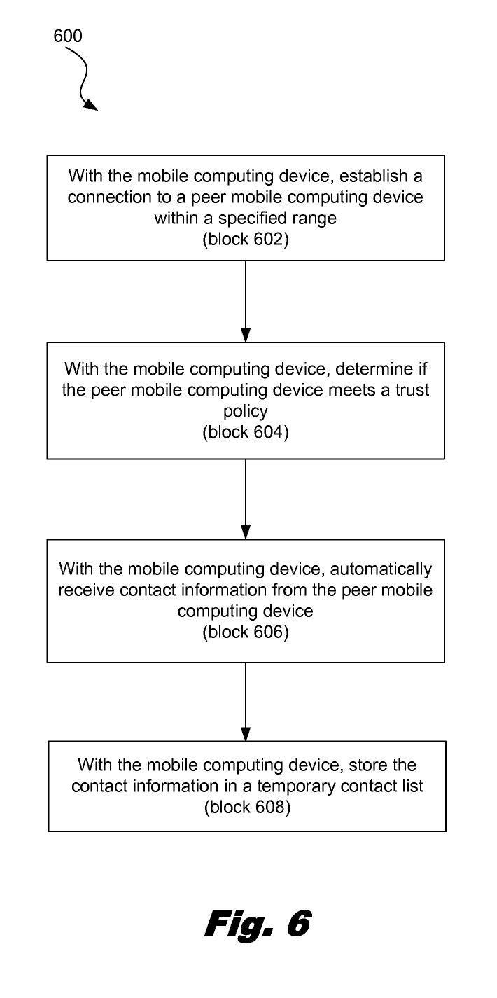

FIG. 6 is a flowchart showing an illustrative method for sharing contact information. According to certain illustrative embodiments, the method may include, With the mobile computing device, establishing (block 602) a connection to a peer mobile computing device within a specified range, determining (block 604) if the peer mobile computing device meets a trust policy, automatically receiving (block 606) contact information from the peer mobile computing device, and storing (block 608) the contact information in a temporary contact list.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for exchanging contact information, the method comprising:
with a mobile computing device, establishing communication with a peer mobile computing device that is within a specified distance from the mobile computing device;
with said mobile computing device, determining if said peer mobile computing device meets a trust policy; and
with said mobile computing device, automatically receiving contact information from said peer mobile computing device; and
with said mobile computing device, storing said contact information in a temporary contact list.

2. The method of claim 1, wherein determining if said peer mobile computing device meets said trust policy comprises a determination of whether a user of said mobile computing device and a user of said peer mobile computing device belong to a same group.

3. The method of claim 1, wherein determining if said peer mobile computing device meets said trust policy comprises a determination of whether said mobile computing device being set to a collect mode.

4. The method of claim 3, wherein said collect mode is configured to turn on and off based on a schedule defined by a user of said mobile computing device.

5. The method of claim 1, wherein determining if said peer mobile computing device meets said trust policy comprises a determination of whether an event within a scheduling application on said mobile computing device matches an event within a scheduling application on said peer mobile computing device.

6. The method of claim 1, wherein determining if said peer mobile computing device meets said trust policy comprises a determination of whether said mobile computing device is within said specified distance of said peer mobile computing device for a predefined amount of time.

7. The method of claim 1, further comprising, while in a post mode, with said mobile computing device, sending contact information to said peer mobile computing device, said sent contact information to be stored in a temporary contact list of said peer mobile computing device.

8. The method of claim 1, further comprising, with said mobile computing device, providing a user with an option to review said contact information stored in said temporary contact list and select contact information within said temporary contact list for transfer to a permanent contact list.

9. The method of claim 1, wherein contact information within said temporary contact list is automatically removed after a predetermined period of time.

10. A mobile computing device comprising:
a processor; and
a memory communicatively coupled to said processor;
in which said processor is configured to:
establish communication with a peer mobile computing device when said mobile computing device and said peer mobile computing device are both within a particular geographic range;
determine if said peer mobile computing device meets a trust policy;
exchange contact information from said peer mobile computing device in accordance with said trust policy.

11. The device of claim 10, wherein determining if said peer mobile computing device meets said trust policy comprises a determination of whether a user of said mobile computing system belongs to a same group as a user of said peer mobile computing device.

12. The device of claim 10, wherein determining if said peer mobile computing device meets said trust policy comprises a determination of whether said mobile computing system being set to a collect mode.

13. The device of claim 10, wherein determining if said peer mobile computing device meets said trust policy comprises a determination of whether an event within a scheduling application on said mobile computing system matches an event within a scheduling application on said peer mobile computing device.

14. The device of claim 10, wherein determining if said peer mobile computing device meets said trust policy comprises a determination of whether said mobile computing system is within said particular geographic range of said peer mobile computing device for a predefined amount of time

15. The device of claim 10, wherein contact information obtained by said device is placed in a temporary contact list.

16. The device of claim 15, wherein said processor is further configured to provide a user with an option to review contact data in said temporary contact list and select contact information within said temporary contact list for transfer to a permanent contact list.

17. A computer program product for a mobile computing device, said computer program product comprising:
a computer readable storage medium having computer readable code embodied therewith, said computer readable program code comprising:
computer readable program code configured to establish communication with a peer mobile computing device within a specified physical range from the mobile computing device;
computer readable program code configured to determine if said peer mobile computing device meets a trust policy;
computer readable program code configured to receive contact information from said peer mobile computing device; and
computer readable program code configured to place said contact information in a temporary contact list stored on said memory.

18. The computer program product of claim 17, wherein determining if said peer mobile computing device meets said trust policy comprises a determination of whether said mobile computing system belonging to a same group as said peer mobile computing device.

19. The computer program product of claim 17, wherein determining if said peer mobile computing device meets said trust policy comprises a determination of whether said mobile computing system is set to one of: a share mode, a collect mode, and a post mode.

20. The computer program product of claim 17, wherein determining if said peer mobile computing device meets said trust policy comprises a determination of whether an event within a scheduling application on said mobile computing system matches an event within a scheduling application on said peer mobile computing device.
